(19) United States
(12) Patent Application Publication
(10) Pub. No.: US 2019/0213137 A1
(43) Pub. Date: Jul. 11, 2019

(54) METHOD FOR MANAGING FLASH MEMORY MODULE AND ASSOCIATED FLASH MEMORY CONTROLLER AND ELECTRONIC DEVICE

(71) Applicant: Silicon Motion Inc., Hsinchu County (TW)

(72) Inventors: Chien-Cheng Lin, Yilan County (TW); Chia-Chi Liang, Hsinchu County (TW); Jie-Hao Lee, Kaohsiung City (TW)

(21) Appl. No.: 16/022,714

(22) Filed: Jun. 29, 2018

(30) Foreign Application Priority Data
Jan. 5, 2018 (TW) 107100464

(51) Int. Cl. G06F 12/10

(52) U.S. Cl. CPC G06F 12/10; G06F 2212/7205; G06F 2212/7201; G06F 2212/1044

(57) ABSTRACT

The present invention provides a method for managing a flash memory module, wherein the method comprises: reading a logical address to physical address (L2P) mapping table from the flash memory module; compressing the L2P mapping table to generate a compressed mapping table, wherein the compressed mapping table records a reference physical address and whether a corresponding physical address of each logical address is the reference physical address plus an offset value; and when receiving a read command asking for reading data corresponding to a specific logical address, referring to the compressed mapping table to determine a specific physical address corresponding to the specific logical address, and reading the data from the flash memory module according to the specific physical address.

### BACKGROUND OF THE INVENTION

### 1. Field of the Invention

The present invention relates to a flash memory, and more particularly, to a method for managing a flash memory module and a related flash memory controller and an electronic device.

### 2. Description of the Prior Art

When a flash memory controller needs to read data in a flash memory module, the flash memory controller needs to search for one or more logical address to physical address (L2P) mapping tables to find the physical address of the required information. In order to speed up finding the correct L2P mapping table and searching for the physical address, a buffer memory is provided in the flash memory controller to temporarily store multiple L2P mapping tables. However, since the buffer memory has limited space and therefore cannot access too many L2P mapping table. If for some applications with smaller address management units, for example, using 4 KB as a unit to record the logical addresses and the physical addresses, it will seriously reduce the number of the L2P mapping table that can be stored in the buffer, and this will result in that the flash memory controller needs to frequently read the required L2P mapping tables from external components (for example, DRAM or the flash memory module), and the read efficiency is reduced.

### SUMMARY OF THE INVENTION

Therefore, one of the objectives of the present invention is to provide a method for managing a flash memory module, which can improve the reading efficiency with a limited buffer memory capacity, to solve the above-mentioned problem.

According to a first aspect of the present invention, an exemplary method for managing a flash memory module is disclosed. The method comprises: reading a logical address to physical address (L2P) mapping table from the flash memory module; compressing the L2P mapping table to generate a compressed mapping table, wherein the compressed mapping table records a reference physical address and whether a corresponding physical address of each logical address is the reference physical address plus an offset value; when receiving a read command asking for reading data corresponding to a specific logical address, referring to the compressed mapping table to determine a specific physical address corresponding to the specific logical address, and reading the data from the flash memory module according to the specific physical address.

According to a second aspect of the present invention, an exemplary flash memory controller is disclosed, wherein the flash memory controller is utilized for accessing a flash memory module, and the flash memory controller comprises: a read-only memory (ROM) and a microprocessor. The ROM is utilized for storing a code. The microprocessor is utilized for executing the code to control access to the flash memory module, wherein the microprocessor reads a logical address to physical address (L2P) mapping table from the flash memory module, and compresses the L2P mapping table to generate a compressed mapping table, wherein the compressed mapping table records a reference physical address and whether a corresponding physical address of each logical address is the reference physical address plus an offset value; and when receiving a read command asking for reading data corresponding to a specific logical address, the microprocessor refers to the compressed mapping table to determine a specific physical address corresponding to the specific logical address, and reads the data from the flash memory module according to the specific physical address.

According to a third aspect of the present invention, an exemplary electronic device is disclosed. The electronic device comprises: a flash memory module and a flash memory controller. The flash memory controller is utilized for accessing the flash memory module, wherein the flash memory controller reads a logical address to physical address (L2P) mapping table from the flash memory module, and compresses the L2P mapping table to generate a compressed mapping table, wherein the compressed mapping table records a reference physical address and whether a corresponding physical address of each logical address is the reference physical address plus an offset value; and when receiving a read command asking for reading data corresponding to a specific logical address, the flash memory controller refers to the compressed mapping table to determine a specific physical address corresponding to the specific logical address, and reads the data from the flash memory module according to the specific physical address.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a memory device according to an embodiment of the present invention.

FIG. 2 is a flow chart of accessing the flash memory module according to a first embodiment of the present invention.

FIG. 3 is a diagram illustrating an L2P mapping table.

FIG. 4 is a diagram illustrating a compressed mapping table.

FIG. 5 is a flow chart of accessing the flash memory module according to a second embodiment of the present invention.

FIG. 6 is a diagram of a random data mapping table according to an embodiment of the present invention.

### DETAILED DESCRIPTION

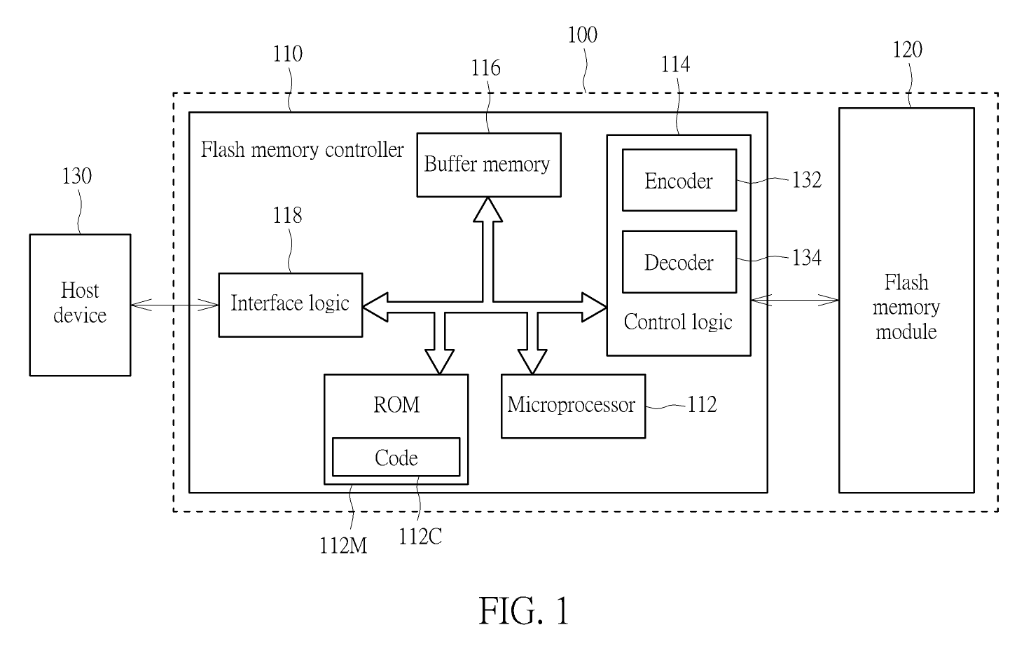

Please refer to FIG. 1. FIG. 1 is a diagram illustrating a memory device 100 according to an embodiment of the present invention. The memory device 100 comprises a flash memory module 120 and a flash memory controller 110, and the flash memory controller 110 is utilized to access the flash memory module 120. According to this embodiment, the flash memory controller 110 comprises a microprocessor 112, a read-only memory (ROM) 112M, a control logic 114, a buffer memory 116, and an interface logic 118. The ROM 112M is utilized to store a code 112C, and the microprocessor 112 is utilized to execute the code 112C to control the access to the flash memory module 120. The control logic 114 comprises an encoder 132 and a decoder 134, wherein the encoder 132 is utilized for encoding the data written in the flash memory module 120˜produce a corresponding check code (or error correction (ECC), and the decoder 134 is utilized for decoding the data read from the flash memory module 120.

In a typical situation, the flash memory module 120 comprises a plurality of flash memory chips, and each flash memory chip comprises a plurality of blocks, and the data erasing operation for the flash memory module 120 by the controller (e.g., the flash memory controller 110 executing the code 112C via the microprocessor 112) is performed in units of blocks. In addition, a block can record a specific number of data pages (data pages) in which the data writing operation for the flash memory module 120 by the controller (e.g., the flash memory controller 110 executing the code 112C via the microprocessor 112) is performed to write in units of data pages. In this embodiment, the flash memory module 120 is a three-dimensional NAND type flash memory (3D NAND-type flash).

In practice, the flash memory controller 110 executing the code 112C via the microprocessor 112, can perform a number of control operations by using its own internal components, such as controlling the flash memory module 120 by using the control logic 114 (especially the access operations for at least one block or at least one data page), buffering the required buffering operations by using the buffer memory 116, and using the interface logic 118 to communicate with a host device 130. The buffer memory 116 is implemented in a random access memory (RAM). For example, the buffer memory 116 can be a static random access memory (SRAM), but the present invention is not limited thereto.

In an embodiment, the memory device 100 can be a portable memory device (e.g., a memory card that complies with to the SD/MMC, CF, MS, XD standard), and the host device 130 can be an electronic device capable of connecting to the memory device, such as cell phones, laptops, desktops, etc. In another embodiment, the memory device 100 can be a solid-status hard disk or an embedded storage that complies with Universal Flash Storage (UFS) or Embedded Multi Media Card (EMMC) specification, which is provided in an electronic device, such as in a mobile phone, a notebook computer, a desktop computer, and the host device 130 can be a processor of the electronic device.

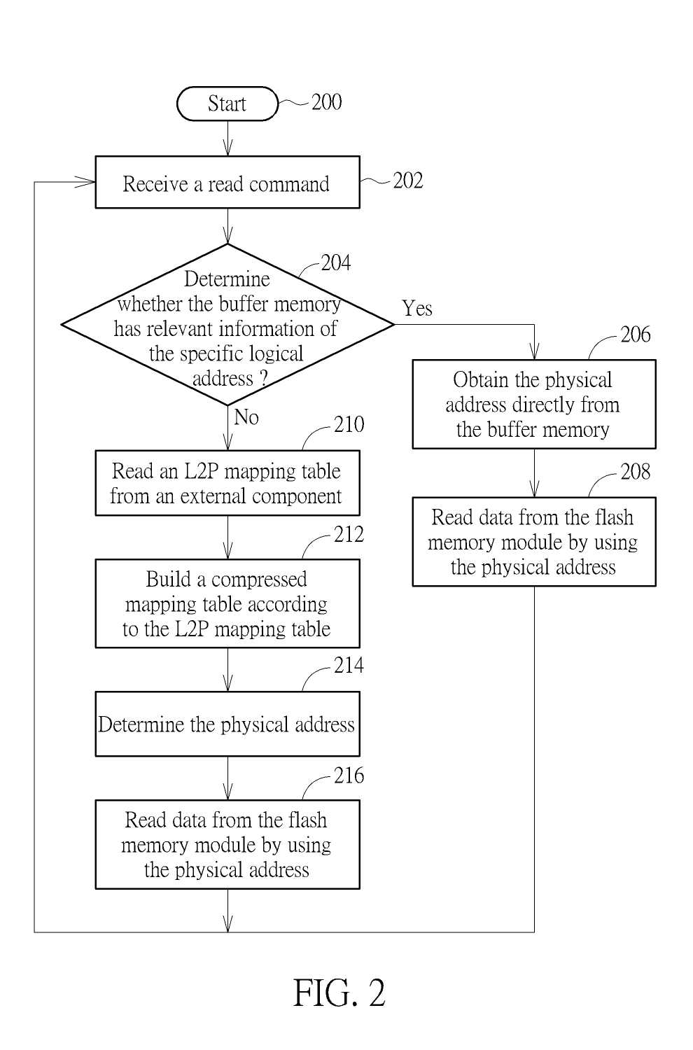

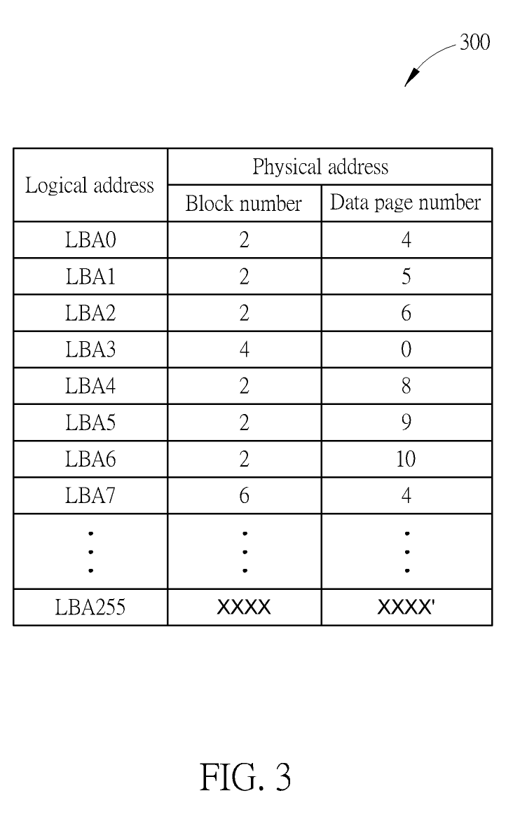

Please refer to FIG. 2. FIG. 2 is a flow chart of a method for accessing the flash memory module 120 according to a first embodiment of the present invention. Referring to FIG. 2, in the step 200, the flow starts and the memory device 100 is powered on. In the step 202, the flash memory controller 110 receives a read command from the host device to request for reading data having a specific logical address from the flash memory module 120. In the step 204, the microprocessor 112 determines whether the buffer memory 116 has relevant information of the specific logical address. If yes, the flow goes to the step 206. Otherwise, the flow goes to the step 210. It is assumed here that the current buffer memory 116 has not stored the information related to the specific logical address. Therefore, the description starts with the step 210. In the step 210, the flash memory controller 110 reads a logical address to physical address (L2P) mapping table from an external component according to the specific logical address, wherein the external component can be a flash memory module 120 or a dynamic random access memory. For example, in general, multiple L2P mapping tables are stored in the flash memory module 120, and each L2P mapping table comprises multiple consecutive logical addresses and/or corresponding physical addresses (Note that not each logical address necessarily has a corresponding physical address). For example, the first L2P mapping table comprises logical addresses LBA0˜LBA255, and the second L2P mapping table comprises logical addresses LBA256˜LBA511, and the third L2P mapping table comprises logical addresses LBA512˜LBA767, . . . , and so on. In this embodiment, assuming that the specific logical address comprised in the read command is LBA2, the flash memory controller 110 reads the first L2P mapping table from the external component and temporarily store the read L2P mapping table in the buffer memory 116. FIG. 3 is a schematic diagram of an L2P mapping table 300 according to an embodiment of the present invention. The L2P mapping table 300 records consecutive logical addresses LBA0˜LBA255 and corresponding physical addresses, wherein the physical addresses comprise block numbers in the memory module 120 and data page numbers therein.

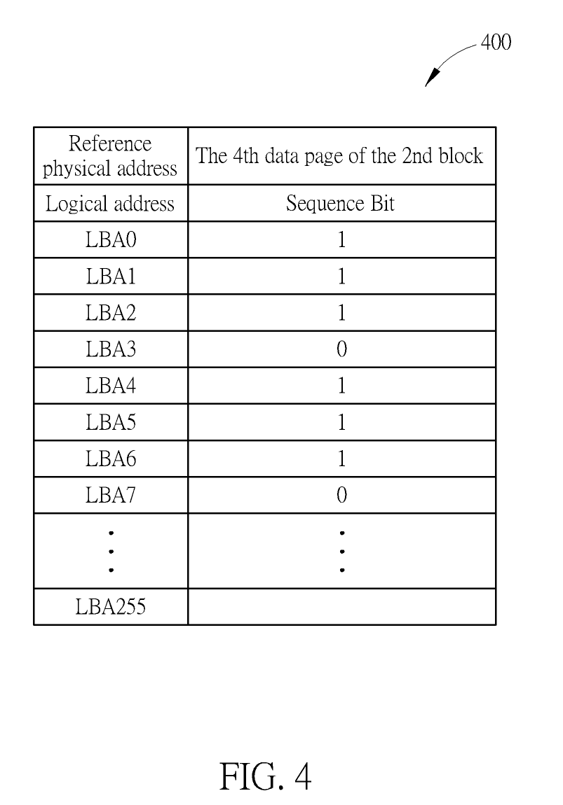

In the step 212, the microprocessor 112 compresses the read L2P mapping table to generate a compressed mapping table, wherein the compressed mapping table records a reference physical address and whether the corresponding physical address of each logical address is the reference physical address plus an offset value. Referring to FIG. 4, which is a schematic diagram of a compressed mapping table 400 according to an embodiment of the present invention, wherein the compressed mapping table 400 is obtained according to the L2P mapping table 300 shown in FIG. 3. In FIG. 4, the reference physical address can be the physical address of the first logical address LBA0 in the L2P mapping table 300, and therefore in this embodiment, the reference physical address is the fourth data page of the second block. In addition, the compressed mapping table 400 records the logical addresses LBA0˜LBA255 and corresponding sequence bits, wherein the sequence bits represent whether the corresponding physical address of each logical address is the reference physical address plus an offset value, and also represent whether the corresponding data of the logical address LBA0 is consecutive data when originally writing the data. Specifically, in the L2P mapping table 300 shown in FIG. 3, the data of the logical addresses LBA0˜LBA7 should be written to the fourth to eleventh data pages of the second block in the first place, but later the data of LBA3 and LBA7 has been updated to be additionally written to other physical address. Therefore, the compressed mapping table 400 can set the sequence bits of LBA0˜LBA2 and LBA4˜LBA6 to be “1” and the sequence bits of LBA3 and LBA7 to be “0”. In this embodiment, the corresponding offset of each logical address is the sequence number of each logical address, that is, the physical address of the logical block LBA0 (the fourth data page of the second block) can be the reference physical address (the fourth data page of the second block) plus an offset value (0 data page). The physical address of the logical block LBA1 (the fifth data page of the second block) can be the reference physical address (the fourth data page of the second block) plus an offset value (1 data page). The physical address of the logical block LBA2 (the sixth data page of the second block) can be the base physical address (the fourth data page of the second block) plus the offset value (2 data pages). The physical address of the logical block LBA4 (the eighth data page of the second block) can be the base physical address (the fourth data page of the second block) plus the offset value (4 data pages). The physical address of the logical block LBA5 (the ninth data page of the second block) can be the base physical address (the fourth data page of the second block) plus the offset value (5 data pages). The physical address of block LBA6 (the tenth data page of the second block) can be the base physical address (the fourth data page of the second block) plus the offset value (6 data pages), . . . , and so on.

In the compressed mapping table 400 shown in FIG. 4, a single bit is utilized to record whether the data of each logical address is consecutive data, that is, to record whether the corresponding physical address of each logical address is the reference physical address plus an offset value. Therefore, the compressed mapping table 400 has only a small capacity, which is about ( 1/32) of that of the L2P mapping table 300. In addition, the compressed mapping table 400 is stored in the buffer memory 116.

Next, in the step 214, the microprocessor 112 can use the compressed mapping table 400 or the L2P mapping table 300 to determine the physical address corresponding to the specific logical address of the read command. Assuming that the specific logical address is LBA2, since the sequence bit corresponding to the logical address LBA2 in the compressed mapping table 400 is 1, the microprocessor 112 can simply set the reference physical address (the fourth data page of the second block) plus the corresponding offset value (2 data pages) of the logical address LBA2 to quickly obtain the physical address of the logical address LBA2 (the sixth data page of the second block) without searching the L2P mapping table 300, so as to improve the efficiency of the flash memory controller 110.

In the step 216, the microprocessor 112 uses the determined physical address to read the data from the flash memory module 120, and transmits the read data back to the host device 130. After that, the flow returns to the step 202.

Next, assuming that the flash memory controller 110 receives another read command from the host device to request to read the data having the logical addresses LBA6, LBA7 from the flash memory module 120, the relevant information (that is, the L2P mapping table 300 and the compressed mapping table 400) of the logical addresses LBA6 and LBA7 already exists in the current buffer memory 116. Therefore, the flow proceeds from the step 204 to the step 206. In the step 206, the microprocessor 112 firstly refers to the compressed mapping table 400 to determine the physical addresses corresponding to the logical addresses LBA6 and LBA7. If the physical address can not be determined through the compressed mapping table 400, then the L2P mapping table 300 will be utilized again. Specifically, since the sequence bit corresponding to the logical address LBA6 recorded in the compressed mapping table 400 is 1, the microprocessor 112 can simply set the reference physical address (the fourth data page of the second block) plus the corresponding offset value (6 data pages) of the logical address LBA6 to quickly obtain the physical address of the logical address LBA6 (the tenth data page of the second block). In addition, since the compressed mapping table 400 records that the sequence bit corresponding to the logical address LBA7 is 0, so the microprocessor 112 needs to search the L2P mapping table 300 for the physical address corresponding to the logical address LBA7.

In the step 208, the microprocessor 112 uses the determined physical address to read the data from the flash memory module 120, and transmits the read data back to the host device 130. After that, the flow returns to the step 202.

In the above embodiments of FIGS. 2-4, by creating a compressed mapping table 400 with a small capacity, the data required for the read command is written in a consecutive data state at the time of writing, and thus the required physical address information can be quickly obtained to improve the efficiency of the flash memory controller 110.

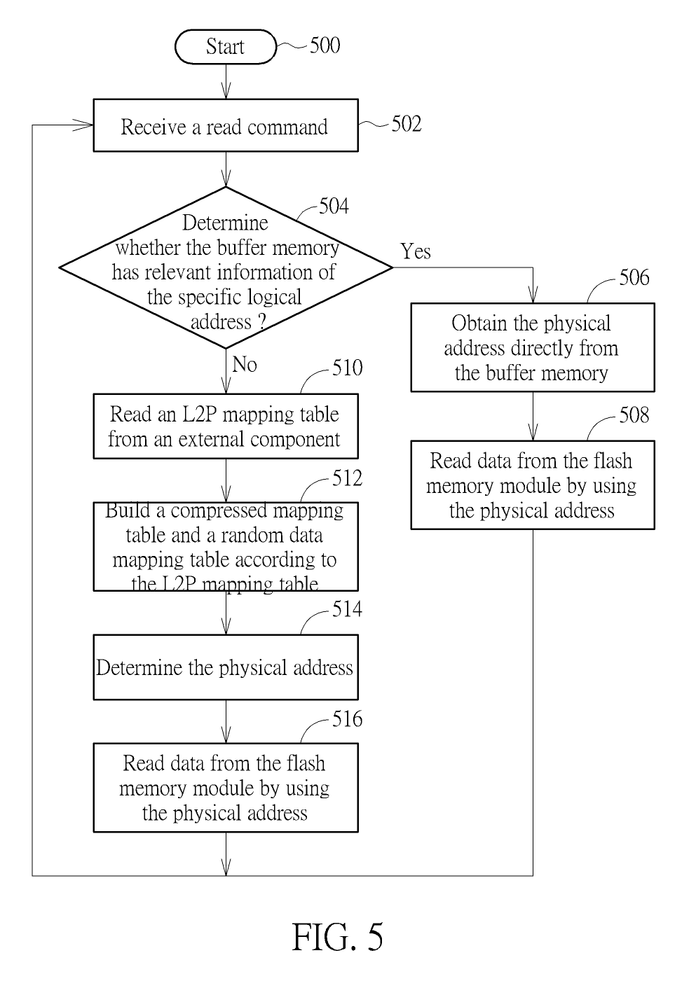

FIG. 5 is a flow chart of a method for accessing the flash memory module 120 according to a second embodiment of the present invention.

Referring to FIG. 5, in the step 500, the flow starts and the memory device 100 is powered on. In the step 502, the flash memory controller 110 receives a read command from the host device to request for reading data having a specific logical address from the flash memory module 120. In the step 504, the microprocessor 112 determines whether the buffer memory 116 has the relevant information of the specific logical address. If yes, the flow goes to the step 506. Otherwise, the flow goes to the step 510. It is assumed here that, at present, the buffer memory 116 has not yet stored the relevant information of the specific logical address. Therefore, the description of the method begins with the step 510. In the step 510, the flash memory controller 110 reads an L2P mapping table from an external component according to the specific logical address, and temporarily stores the read L2P mapping table in the buffer memory 116, wherein the L2P mapping table can be referred to the L2P mapping table 300 shown in FIG. 3.

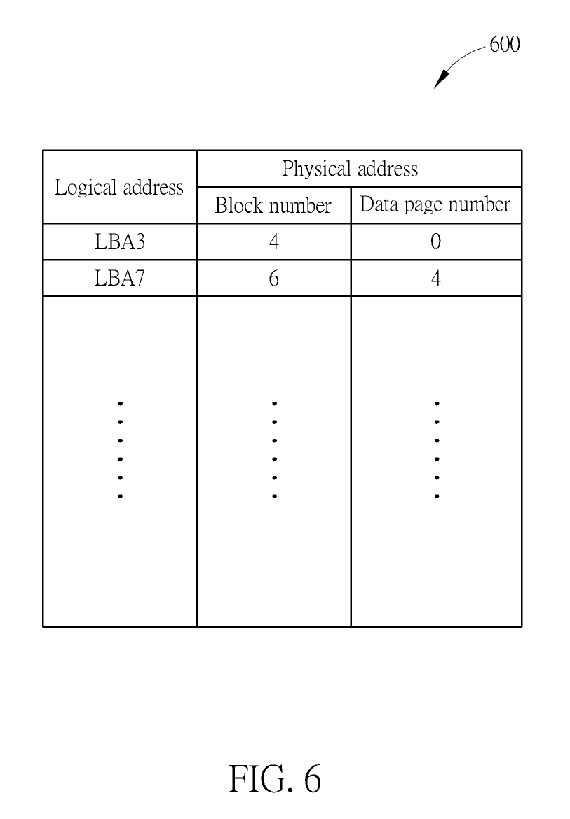

In the step 512, the microprocessor 112 compresses the read L2P mapping table to generate a compressed mapping table and a random data mapping table. The compressed mapping table records a reference physical address and whether the corresponding physical address of each logical address is the reference physical address plus an offset value, and the compressed mapping table can be the compressed mapping table 400 shown in FIG. 4, so the details are not described herein again. Regarding the random data mapping table, it is utilized to record that each logical address whose corresponding physical address is not the reference physical address plus an offset value, and a corresponding physical address thereof. Specifically, FIG. 6 illustrates a schematic diagram of a random data mapping table 600 generated according to the L2P mapping table 300, wherein only the physical addresses of LBA3 and LBA7 are recorded (in the case that LBA8˜LBA255 are also consecutive data).

In this embodiment, the compressed mapping table 400 and the random data mapping table 600 are stored in the buffer memory 116, and since the compressed mapping table 400 and the random data mapping table 600 can completely replace the function of the L2P mapping table 300, the L2P mapping table 300 can be removed from the buffer memory 116 after the compressed mapping table 400 and the random data mapping table 600 are successfully generated, so as to release the space of the buffer memory 116.

Next, in the step 514, the microprocessor 112 can use the compressed mapping table 400 or the L2P mapping table 300 to determine the physical address corresponding to the specific logical address of the read command. Assuming that the specific logical address is LBA1, since the sequence bit corresponding to the logical address LBA1 in the compressed mapping table 400 is 1, the microprocessor 112 can simply set the reference physical address (the fourth data page of the second block) plus the corresponding offset value (1 data page) of the logical address LBA2 to quickly obtain the physical address of the logical address LBA1 (the fifth data page of the second block). In addition, suppose The specific logical address is LBA3, then the microprocessor 112 can search out the physical address corresponding to the logical address LBA3 from the random data mapping table 600, and since the data amount in the random data mapping table 600 is small, the amount of time that the microprocessor 112 spends in searching can also be significantly reduced.

In the step 516, the microprocessor 112 uses the determined physical address to read the data from the flash memory module 120, and transmits the read data to the host device 130. Next, the flow returns to the step 502.

Next, assuming that the flash memory controller 110 receives another read command from the host device to request that the data having the logical addresses LBA6 and LBA7 to read from the flash memory module 120, since the current buffer memory 116 already has the related information of the logical addresses LBA6 and LBA7 (i.e. the compressed mapping table 400 and the random map 600), the flow will proceed from the step 504 to the step 506. Since the operations of the steps 506 and 508 are respectively the same as the steps 514 and 516, the details are not described herein again.

In the above embodiment of FIG. 5, in addition to enhancing the efficiency of the flash memory controller 110 by establishing a compressed mapping table 400 having a small capacity, a random data mapping table 600 is further established to be utilized when the physical address cannot be determined by the compressed mapping table 400. In addition, since the consecutive data accounts for about 80% of the data and the random data is about 20% of the data in the general file system, the compressed mapping table 400 and random data mapping table 600 add up to far less capacity than the L2P mapping table, and thus the buffer memory 116 can have more space to store other information in a case that the compressed mapping table 400 and random data mapping table 600 can completely replace the function of the L2P mapping table.

On the other hand, since the compressed mapping table 400 and the random data mapping table 600 have a small capacity, a plurality of compressed mapping tables 400 and random data mapping tables 600 generated by different L2P mapping tables can reside on the buffer memory 116, so that when a read command is received, the required physical address can be quickly and directly obtained from the buffer memory 116 to speed up the reading efficiency.

Briefly summarized the present invention, in the method for managing a flash memory module of the present invention, by setting up a compressed mapping table and a random data mapping table, it is possible to make the flash memory controller temporarily store many L2P mapping tables with a limited buffer memory capacity, in order to further increase the reading efficiency and solve the problems in the prior art.

Those skilled in the art will readily observe that numerous modifications and alterations of the device and method can be made while retaining the teachings of the invention. Accordingly, the above disclosure should be construed as limited only by the metes and bounds of the appended claims.

What is claimed is:

1. A method for managing a flash memory module, comprising:
reading a logical address to physical address (L2P) mapping table from the flash memory module;
compressing the L2P mapping table to generate a compressed mapping table, wherein the compressed mapping table records a reference physical address and whether a corresponding physical address of each logical address is the reference physical address plus an offset value;
when receiving a read command asking for reading data corresponding to a specific logical address, referring to the compressed mapping table to determine a specific physical address corresponding to the specific logical address, and reading the data from the flash memory module according to the specific physical address.

2. The method of claim 1, wherein the L2P mapping table and the compressed mapping table both comprise a plurality of consecutive logical addresses, and for each logic address, the compressed mapping table uses a bit to record whether the corresponding physical address of the logical address is the reference physical address plus an offset value.

3. The method of claim 2, wherein for each logical address, when the corresponding bit has a first logical value, it indicates that the corresponding physical address of the logical address is the reference physical address plus an offset value; and when the corresponding bit has a second logic value, it indicates that the corresponding physical address of the logical address is not the reference physical address plus an offset value.

4. The method of claim 1, wherein the step of referring to the compressed mapping table to determine the specific physical address corresponding to the specific logical address comprises:
if the compressed mapping table records that the corresponding physical address of the logical address is the reference physical address plus an offset value, directly adding the offset value to the corresponding physical address of the logical address to determine the specific logical address; and
if the compressed mapping table records that the corresponding physical address of the logical address is not the reference physical address plus an offset value, determining the specific logical address according to the L2P mapping table.

5. The method of claim 1, further comprising:
building a random data mapping table which records each logical address whose corresponding physical address is not the reference physical address plus an offset value, and a corresponding physical address thereof.

6. The method of claim 5, wherein the L2P mapping table and the compressed mapping table both comprise a plurality of consecutive logical addresses, and for each logic address, the compressed mapping table uses a bit to record whether the corresponding physical address of the logical address is the reference physical address plus an offset value; and when the corresponding bit has a first logical value, it indicates that the corresponding physical address of the logical address is the reference physical address plus an offset value; and when the corresponding bit has a second logic value, it indicates that the corresponding physical address of the logical address is not the reference physical address plus an offset value.

7. The method of claim 6, wherein the corresponding bit in the compressed mapping table of each logical address recorded in the random data mapping table has the second logical value.

8. The method of claim 5, wherein the step of referring to the compressed mapping table to determine the specific physical address corresponding to the specific logical address comprises:
if the compressed mapping table records that the corresponding physical address of the logical address is the reference physical address plus an offset value, directly adding the offset value to the corresponding physical address of the logical address to determine the specific logical address; and
if the compressed mapping table records that the corresponding physical address of the logical address is not the reference physical address plus an offset value, determining the specific logical address according to the random data mapping table.

9. The method of claim 5, wherein the L2P mapping table, the compressed mapping table, and the random data mapping table are stored in a buffer memory of the flash memory controller, and after the compressed mapping table and the random data mapping table are successfully generated, the L2P mapping table is no longer utilized to determine any physical address.

10. A flash memory controller, wherein the flash memory controller is utilized for accessing a flash memory module, and the flash memory controller comprises:
a read-only memory, for storing a code; and
a microprocessor, for executing the code to control access to the flash memory module;
wherein the microprocessor reads a logical address to physical address (L2P) mapping table from the flash memory module, and compresses the L2P mapping table to generate a compressed mapping table, wherein the compressed mapping table records a reference physical address and whether a corresponding physical address of each logical address is the reference physical address plus an offset value; and when receiving a read command asking for reading data corresponding to a specific logical address, the microprocessor refers to the compressed mapping table to determine a specific physical address corresponding to the specific logical address, and reads the data from the flash memory module according to the specific physical address.

11. The flash memory controller of claim 10, wherein the L2P mapping table and the compressed mapping table both comprise a plurality of consecutive logical addresses, and for each logic address, the compressed mapping table uses a bit to record whether the corresponding physical address of the logical address is the reference physical address plus an offset value.

12. The flash memory controller of claim 11, wherein for each logical address, when the corresponding bit has a first logical value, it indicates that the corresponding physical address of the logical address is the reference physical address plus an offset value; and when the corresponding bit has a second logic value, it indicates that the corresponding physical address of the logical address is not the reference physical address plus an offset value.

13. The flash memory controller of claim 10, wherein if the compressed mapping table records that the corresponding physical address of the logical address is the reference physical address plus an offset value, the microprocessor directly adds the offset value to the corresponding physical address of the logical address to determine the specific logical address; and if the compressed mapping table records that the corresponding physical address of the logical address is not the reference physical address plus an offset value, the microprocessor determines the specific logical address according to the L2P mapping table.

14. The flash memory controller of claim 10, wherein the microprocessor further builds a random data mapping table which records each logical address whose corresponding physical address is not the reference physical address plus an offset value, and a corresponding physical address thereof.

15. The flash memory controller of claim 14, wherein the L2P mapping table and the compressed mapping table both comprise a plurality of consecutive logical addresses, and for each logic address, the compressed mapping table uses a bit to record whether the corresponding physical address of the logical address is the reference physical address plus an offset value; and when the corresponding bit has a first logical value, it indicates that the corresponding physical address of the logical address is the reference physical address plus an offset value; and when the corresponding bit has a second logic value, it indicates that the corresponding physical address of the logical address is not the reference physical address plus an offset value.

16. The flash memory controller of claim 15, wherein the corresponding bit in the compressed mapping table of each logical address recorded in the random data mapping table has the second logical value.

17. The flash memory controller of claim 14, wherein if the compressed mapping table records that the corresponding physical address of the logical address is the reference physical address plus an offset value, the microprocessor directly adds the offset value to the corresponding physical address of the logical address to determine the specific logical address; and if the compressed mapping table records that the corresponding physical address of the logical address is not the reference physical address plus an offset value, the microprocessor determines the specific logical address according to the random data mapping table.

18. The flash memory controller of claim 14, wherein the L2P mapping table, the compressed mapping table, and the random data mapping table are stored in a buffer memory of the flash memory controller, and after the compressed mapping table and the random data mapping table are successfully generated, the L2P mapping table is no longer utilized to determine any physical address.

19. An electronic device, comprising:
a flash memory module; and
a flash memory controller, for accessing the flash memory module;
wherein the flash memory controller reads a logical address to physical address (L2P) mapping table from the flash memory module, and compresses the L2P mapping table to generate a compressed mapping table, wherein the compressed mapping table records a reference physical address and whether a corresponding physical address of each logical address is the reference physical address plus an offset value; and when receiving a read command asking for reading data corresponding to a specific logical address, the flash memory controller refers to the compressed mapping table to determine a specific physical address corresponding to the specific logical address, and reads the data from the flash memory module according to the specific physical address.

20. The electronic device of claim 19, wherein the flash memory controller further builds a random data mapping table which records each logical address whose corresponding physical address is not the reference physical address plus an offset value, and a corresponding physical address thereof.
